(19) United States
(12) Patent Application Publication
(10) Pub. No.: US 2024/0121204 A1
(43) Pub. Date: Apr. 11, 2024

(54) SCHEDULE SEND SUGGESTION IN AN APPLICATION CHAT

(71) Applicant: Microsoft Technology Licensing, LLC, Redmont, WA (US)

(72) Inventors: Jiaoyan ZHANG, Suzhou City (CN); Wendy GUO, Edmonds, WA (US); John Hay TAING, Renton, WA (US); Vineet BATTA, Bothell, WA (US); Yury ISAKOV, Redmond, WA (US); Simon Chun Ho TAM, Redmond, WA (US); Jennifer Andrea NINO TAPIA, Kennewick, WA (US); Matthew David WALL, Vancouver, British Columbia (CA); Sean Michael LYNCH, Arlington, WA (US); Milena NATANOV, Bellevue, WA (US); Angelina CONSTANCE, San Francisco, CA (US)

(21) Appl. No.: 18/081,288

(22) Filed: Dec. 14, 2022

Related U.S. Application Data
(60) Provisional application No. 63/414,774, filed on Oct. 10, 2022.

(51) Int. Cl. H04L 51/04; H04L 51/42

(52) U.S. Cl. CPC H04L 51/04; H04L 51/42

(57) ABSTRACT

The present disclosure relates to methods and systems for automatically providing a suggestion to delay sending a message that is being composed by a user to send to a chat participant using a chat feature of an application. The suggestion is sent in response to determining that one or more trigger conditions occurred. The suggestion includes a scheduled time to send the message. The methods and systems send the delayed message at the scheduled time.

### CROSS-REFERENCE TO RELATED APPLICATIONS

This application claims priority to and the benefit of U.S. Provisional Patent Application No. 63/414,774, filed on Oct. 10, 2022, which is hereby incorporated by reference in its entirety.

### BACKGROUND

In today's environment, users at remote locations communicate to one another in a collaborative environment using application tools. For example, users communicate through online meetings using meeting applications. Another example includes users communicating through a chat feature of applications that allows the users to send instant messages to other users using the chat. An increase is occurring in messages being sent using the chat features of applications. Moreover, an increase is occurring in messages being sent using the chat feature of applications outside of work hours.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes receiving a message creation indication that a message is being created by a user in a chat of an application. The method includes determining that a trigger condition occurred when the message is being created. The method includes triggering a suggestion to delay sending of the message until a scheduled time in response to determining that the trigger condition occurred. The method includes creating, in response to the user selecting to delay sending of the message, a delayed message. The method includes causing the delayed message to be presented in the chat on a device of the user with an icon presented nearby the delayed message indicating that the delayed message is scheduled to send at the scheduled time, wherein the delayed message is unavailable in the chat viewed by a chat participant selected to receive the message.

Some implementations relate to a device. The device includes a processor; memory in electronic communication with the processor; and instructions stored in the memory, the instructions being executable by the processor to: receive a message creation indication that a message is being created by a user in a chat of an application; determine that a trigger condition occurred when the message is being created; trigger a suggestion to delay sending of the message until a scheduled time in response to determining that the trigger condition occurred; create, in response to the user selecting to delay sending of the message, a delayed message; cause the delayed message to be presented in the chat on a device of the user with an icon presented nearby the delayed message indicating that the delayed message is scheduled to send at the scheduled time, wherein the delayed message is unavailable in the chat viewed by a chat participant selected to receive the message; and store the delayed message at a location remote from the device of the user to send the delayed message at the scheduled time.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for using a chat of an application in accordance with implementations of the present disclosure.

FIG. 2A illustrates an example graphical user interface (GUI) of a chat and presenting a suggestion to delay sending a message in the chat in accordance with implementations of the present disclosure.

FIG. 2B illustrates an example GUI of a chat and changing a scheduled time to delay sending a message in the chat in accordance with implementations of the present disclosure.

FIG. 2C illustrates an example GUI of a chat and presenting a delayed message in a chat of a user that created the delayed message in accordance with implementations of the present disclosure.

FIG. 2D illustrates an example GUI of a chat and providing a feature to edit a delayed message in accordance with implementations of the present disclosure.

FIG. 2E illustrates an example GUI of a chat and providing edits to a delayed message in accordance with implementations of the present disclosure.

FIG. 2F illustrates an example GUI of a chat and presenting an edited delayed message in a chat of a user that created the edited delayed message in accordance with implementations of the present disclosure.

FIG. 2G illustrates an example GUI of a chat and presenting a feature to delete a delayed message in accordance with implementations of the present disclosure.

FIG. 2H illustrates an example GUI of a chat illustrating that a delayed message is deleted from a chat of the user that created the delayed message in accordance with implementations of the present disclosure.

FIG. 3A illustrates an example GUI of a chat presented on a mobile device of a user and presenting a suggestion to delay sending a message in the chat in accordance with implementations of the present disclosure.

FIG. 3B illustrates an example GUI of a chat presented on a mobile device of a user and presenting a delayed message in the chat of the user that created the delayed message in accordance with implementations of the present disclosure.

FIG. 3C illustrates an example GUI of a chat presented on a mobile device of a user and rescheduling a scheduled time to delay sending a delayed message in the chat in accordance with implementations of the present disclosure.

FIG. 3D illustrates an example GUI of a chat presented on a mobile device of a user and rescheduling a scheduled time to delay sending a delayed message in the chat in accordance with implementations of the present disclosure.

FIG. 4 illustrates an example method for providing a suggestion to delay sending of a message in a chat and delaying a sending of the message in accordance with implementations of the present disclosure.

FIG. 5 illustrates components that may be included within a computer system.

### DETAILED DESCRIPTION

This disclosure generally relates to using a chat feature of an application. In today's environment, users remote from each other communicate to one another in a collaborative environment using application tools. For example, users communicate through online meetings using meeting applications. In addition, users communicate with each other through a chat feature of applications that allows the users to send instant messages to other users using the chat feature. The chat feature of the applications also allows users to collaborate with other users through the chat. An increase is occurring in messages being sent using the chat feature of applications. Moreover, an increase is occurring in messages being sent using the chat feature of applications outside of work hours. Answering messages outside of work hours can be detrimental to users by reducing job performance. In addition, answers messages outside of work hours can be damaging to users' work-life balance.

The methods and systems of the present disclosure automatically provide a suggestion to delay sending a message that is being composed by a user to send to a chat participant using a chat feature of an application. The suggestion is sent in response to determining that one or more trigger conditions occurred. One example trigger condition includes the chat participant being unavailable at the time the message is being composed. For example, the message is being composed outside of working hours of the chat participant. Another example includes the message is being composed when the chat participant is out of the office. Another example includes the message is being composed when the chat participant is in a meeting or a call.

The suggestion includes a scheduled time to send the message. In some implementations, the scheduled time is a time when the chat participant is available. For example, the scheduled time is during the working hours of the chat participant. Thus, the suggestion helps the user schedule the message delivery to the chat participant at a time that aligns with the working hours of the chat participant. The methods and systems store the delayed message at a remote location until the scheduled time and sends the delayed message in the chat at the scheduled time.

By scheduling the delivery of the message during a time when the chat participant is available, disruptions to the chat participants outside of working hours, or when the chat participants are otherwise unavailable, are minimized. In addition, by scheduling the messages at a time when the chat participant is available, provides users flexibility to work when the users want to work without putting the burden of the user's schedule on coworkers and reducing afterhours collaborations in the workplace. In addition, company policies or laws of countries may require limits on afterhours collaborations among coworkers. Compliance with the polices or laws may be achieved by automatically suggesting a scheduled time for delivery of the messages within the chat participants workhours. Moreover, by scheduling the message for delivery during the workhours of the chat participants afterhours interruptions may be reduced, improving the work-life balance of the chat participants by reducing afterhours collaborations in the workplace.

The methods and systems intelligently suggest a scheduled time for message delivery for the message and reminds the sender of the message that the chat participants are unavailable. In some implementations, the scheduled time for message delivery aligns with the chat participants working hours and out of office information. With one click, the message sender easily confirms the scheduled time and delays sending of the message in the chat. As such, the methods and systems assist users in scheduling the delivery of messages for chats by automatically suggesting the scheduled time for delivery of the messages.

One technical advantage of the methods and systems of the present disclosure is automatically providing a suggestion to delay sending of a message in response to determining that the chat participants are unavailable when the message is being composed. Another technical advantage of the methods and systems of the present disclosure is automatically determining a scheduled time to send the message when the chat participants are available. For example, the methods and systems automatically determine the working hours and time zones of the chat participants for the message and automatically suggests a scheduled time during the working hours of the chat participants for sending the message. By scheduling the messages in the working hours of the chat participants, the users are provided flexibility of working according to their own schedules without interrupting colleagues (the other chat participants) after working hours, and thus, reducing after hours work stress by reducing message interruptions. Moreover, by automatically suggesting scheduling the message, a cognitive load of the user is reduced by automatically providing a scheduled time to send the message based on an availability of the chat participants.

One example use case of the methods and systems include a user is sending a message on a chat to a coworker who is in a different county and is currently outside of their working hours. The methods and systems automatically determine that the coworker is unavailable at the time the message is being composed and sends a suggestion to the user to delay the sending of the message until the start of the work hours for the coworker the next day.

Another example use case of the methods and systems include a user is sending a message on a chat to a coworker who has an availability status of quite hours/personal time that ends in thirty minutes. The methods and systems automatically determine that the coworker is currently in quite hours/personal time based on the availability status and sends a suggestion to the user to delay the sending of the message for thirty minutes at the end of the quite hours.

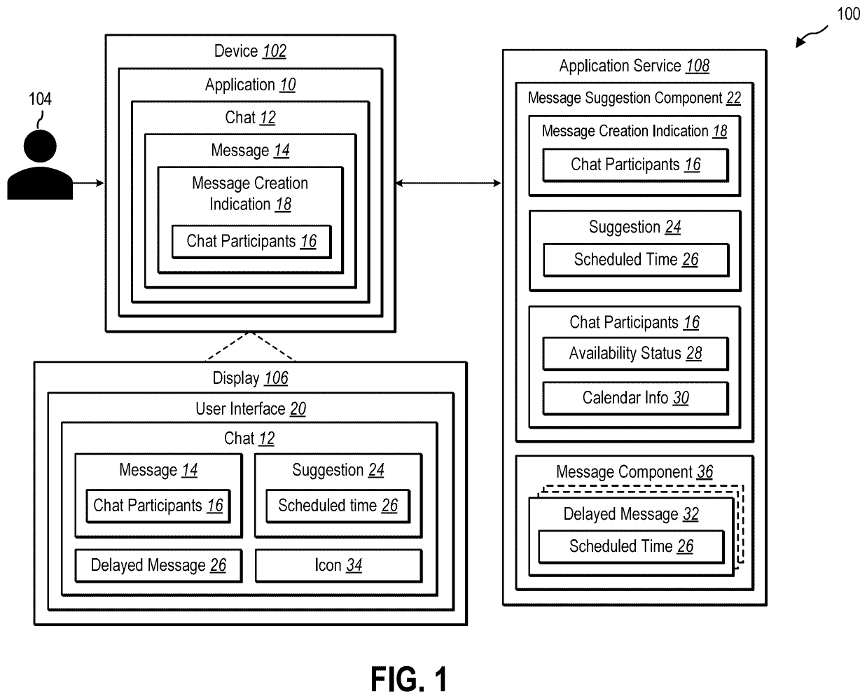

Referring now to FIG. 1, illustrated is an example environment 100 for using a chat 12 feature of an application 10. The chat 12 is a communication platform that offers workspace private chat, group chat, and channels for business messaging. The chat 12 allows users 104 to send instant messages 14 to one another. The application 10 includes any application that supports a chat 12 feature. One example application 10 includes a meeting application that the users 104 use to collaborate with each other through online meetings or the chat 12 feature. In some implementations, the application 10 is local to the device 102 of the users 104. In some implementations, the application 10 is on a server (e.g., a cloud server) remote from the devices 102 of the users 104 accessed, for example, using a web browser on the devices 102 via a network. The network may include one or multiple networks that use one or more communication platforms or technologies for transmitting data. For example, the network may include the Internet or other data link that enables transport of electronic data between respective devices of the environment 100.

The chat 12 is presented on a user interface 20 of a display 106 of the device 102 of the user 104. The chat 12 allows the user 104 to select one or more chat participants 16 to receive a message 14. In some implementations, the chat participants 16 include two users 104 (e.g., a first user composing the message 14 for a recipient to receive the message 14). In some implementations, the chat participants 16 include more than two users 104 (e.g., a first user composing the message 14 to a plurality of other users to receive the message 14). In some implementations, the chat 12 includes messages 14 for different chat participants 16. For example, a first group of messages 14 is for a first chat participant 16 and a second group of messages 14 is for second chat participant 16. Another example includes a first group of messages 14 is for a first chat participant 16 and a second group of messages 14 is for a plurality of chat participants 16. The chat participants 16 may be internal participants to an organization (e.g., the chat participants 16 are members of a same organization) or external participants to an organization (e.g., the chat participants 16 are members of different organizations).

Upon the user 104 creating a message 14 for the chat 12, the application 10 may send a message creation indication 18 to an application service 108 that supports the application 10. The message creation indication 18 indicates that the message 14 is being created by the user 104 in the chat 12 of the application. The message creation indication 18 also includes message information, such as, the chat participants 16 selected for the message 14. The application service 108 coordinates the sending of the messages 14 to the different chat participants 16 to ensure that the user interface 20 presented on the display 106 of each device 102 of the chat participants 16 displays the chat 12 with the messages 14.

The application service 108 includes a message suggestion component 22 that receives the message creation indication 18 with the chat participants 16 identified for the message 14 that the user 104 is composing. The message suggestion component 22 determines whether to trigger a suggestion 24 to delay sending the message 14 until a scheduled time 26 in response to a trigger condition occurring. The trigger condition causes the user 104 (the message 14 creator) to see the suggestion 24 to delay sending the message 14. One example of the trigger condition includes the chat participant 16 (e.g., the recipient of the message 14) is outside of work hours and the user 104 (the message 14 creator) receives a schedule send suggestion (the suggestion 24) to delay the message 14 with a scheduled time 26 (a suggested time that aligns with the start of the message recipient's work hours).

In some implementations, the trigger condition is a chat participant 16 is unavailable. In some implementations, the trigger condition is a chat participant 16 is unavailable to work. In some implementations, the trigger condition is an availability status 28 indicating that the chat participant 16 is unavailable (e.g., offline, away, out of the office, or is outside of working hours). The message suggestion component 22 determines to trigger a suggestion 24 to delay sending the message 14 in response to determining that the message 14 is being created by the user 104 when a chat participant 16 is unavailable. In some implementations, the message suggestion component 22 accesses an availability status 28 of the chat participants 16 in determining whether the chat participant 16 is available. Examples of an availability status 28 include a do not disturb status, an available status, in a meeting status, in a call status, an out of office status, an unavailable status, quite hours status, or an offline status.

In some implementations, the message suggestion component 22 accesses calendar information 30 of the chat participant 16 in determining whether the chat participant 16 is available. For example, the message suggestion component 22 uses the calendar information 30 to identify working hours or preferred working hours of the chat participants 16 and determines that the user 104 is creating the message 14 outside of the working hours of the chat participants 16. Another example includes the message suggestion component 22 using the calendar information 30 to identify that the chat participants 16 are out of the office.

The message suggestion component 22 automatically determines the scheduled time 26 to send the message 14. In some implementations, the scheduled time 26 is when the chat participant 16 is available. In some implementations, the scheduled time 26 includes a plurality of available times for the chat participant 16. For example, the suggestion 24 includes a list of available times for the chat participant 16 and the user 104 selects an available time for the scheduled time 26.

In some implementations, the message suggestion component 22 uses the calendar information 30 to identify work hours for the chat participant 16 and selects an earliest start of the work hours for the scheduled time 26. In some implementations, the message suggestion component 22 uses the calendar information 30 of the chat participants 16 and identifies an earliest overlapping work time of the chat participants 16 for the scheduled time 26. In some implementations, the message suggestion component 22 determines the scheduled time 26 based on preferred working hours of the chat participant 16. In some implementations, the message suggestion component 22 determines the scheduled time 26 based on the working hours of the chat participant 16 and a time zone of the chat participant 16. In some implementations, the message suggestion component 22 determines the scheduled time 26 based on out of office information for the chat participant 16 and selects an earliest time the chat participant 16 is back at work.

In some implementations, the message suggestion component 22 determines the scheduled time 26 based on the availability status 28 of the chat participant 16. For example, the message suggestion component 22 identifies a change in the availability status 28 (e.g., when a call ends or quite hours end) and determines the scheduled time 26 based on a change in the availability status 28.

In some implementations, the message suggestion component 22 communicates with other messaging applications to provide the suggestion 24 and the scheduled time 26 to delay other messages. For example, if the user 104 is composing other forms of messages to the chat participants 16 (e.g., a follow up email message), the message suggestion component 22 may send the suggestion 24 to other applications to recommend delaying the sending of the other messages until the scheduled time 26.

In some implementations, the message suggestion component 22 verifies that a feature is enabled in the application 10 for providing the suggestion 24 to delay sending the messages 14 prior to sending the suggestion 24. In some implementations, the feature is enabled by default. In some implementations, the user 104 opts in to receiving the suggestion 24 to delay sending the message 14 by enabling the feature. In some implementations, the feature is automatically enabled for the user 104. For example, a manager automatically enables the feature to provide the suggestion 24 to delay sending the message 14 for employees on the manager's team. In some implementations, the user 104 disables the feature. If the feature is enabled, the message suggestion component 22 sends the suggestion 24 with the scheduled time 26 to delay the message 14 in response to a trigger condition occurring. If the feature is disabled, the message suggestion component 22 prevents the sending of the suggestion 24 to delay the message 14 in response to a trigger condition occurring. In some implementations, a message status or other indication overrides the enablement of the feature for providing the suggestion 24. For example, an urgent message overrides the sending of the suggestion 24 to delay sending the message 14.

The message suggestion component 22 provides the suggestion 24 with the scheduled time 26 to delay the sending of the message 14 to the application 10 in response to one or more trigger conditions occurring with the message 14. The application 10 presents the suggestion 24 with the scheduled time 26 to delay the sending of the message 14 on the user interface 20 nearby the message 14 being composed by the user 104. If the user 104 dismisses the suggestion 24, the message 14 is created and provided in the chat 12 of the user 104 and the chat participant 16 without delaying a sending of the message 14.

If the user 104 selects to delay the sending of the message 14 (e.g., by selecting an icon or link in the suggestion 24), a delayed message 32 is generated. The application 10 sends the delayed message 32 to the application service 108 for storage until the scheduled time 26. The application service 108 includes a message component 36 that stores the delayed message 32 until the scheduled time 26. The message component 36 causes the delayed message 32 to be presented in the chat 12 of the user 104 that created the delayed message 32 without the delayed message 32 being viewable by the chat participant 16. For example, the delayed message 32 is presented on the chat 12 of the user 104 and is not presented on the chat 12 viewable by the chat participant 16.

In some implementations, the delayed message 32 is visually distinct from other messages 14 in the chat 12 with the participant 16. For example, the delayed message 32 includes an icon 34 that identifies that delayed message 32 is scheduled to send at the scheduled time 26. Another example includes the delayed message 32 is a different color than other messages 14 in the chat 12.

In some implementations, the delayed message 32 includes a feature to select a different scheduled time 26. For example, a list of other times is presented to the user 104 and the user 104 selects a different time for the scheduled time 26 from the list of other times. In some implementations, the delayed message 32 includes an edit feature that allows the user 104 to edit the delayed message 32. Any changes or edits are provided to the application service 108 and stored until the scheduled time 26. In some implementations, the delayed message 32 includes a delete feature that allows the user 104 to delete the delayed message 32. If the user 104 selects to delete the delayed message 32, the delayed message 32 is removed from the storage at the application service 108 and deleted from the chat 12 displayed on the device 102 of the user 104.

The message component 36 also synchronizes the delayed message 32 in the chat 12 of any device 102 that the user 104 uses to access the chat 12 by presenting the delayed message 32 with the icon in the chat 12 on any device 102 that the user uses to access the chat 12. The synchronization of the delayed messages 32 in the chat 12 across devices is platform independent. Thus, regardless of a platform or a device 102 that the user 104 uses to access the chat 12, the delayed message 32 is presented in the chat 12 of the user 104.

One example use case includes if the user 104 uses a work computer to access the chat 12 and create the delayed message 32 while at work, the message component 36 presents the delayed message 32 on the chat 12 of the work computer of the user 104. While commuting home, the user 104 decides to edit the delayed message 32 and accesses the chat 12 from a mobile phone of the user 104. The message component 36 presents the delayed message 32 on the chat of the mobile phone of the user 104 and the user 104 is able to make the edits to the delayed message 32. The delayed message 32 is synchronized across any device that the user 104 uses to access the chat 12.

In addition, the message component 36 sends the delayed messages 32 at the scheduled time 26 to the chat participants 16. As such, at the scheduled time 26, the delayed message 32 is viewable in the chat 12 of the user 104 and the chat participants 16. The delayed message 32 is added to the messages 14 of the chat 12.

In some implementations, one or more computing devices are used to perform the processing of environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, application service 108 (e.g., the message suggestion component 22 and the message component 36) is implemented wholly on the same computing device. Another example includes one or more subcomponents of the application service 108 (e.g., the message suggestion component 22 and the message component 36) implemented across multiple computing devices. Moreover, in some implementations, the application 10 and the application service 108 are implemented or processed on different server devices of the same or different cloud computing networks. Moreover, in some implementations, the features and functionalities are implemented or processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

The environment 100 automatically provides the suggestion 24 with the scheduled time 26 to delay sending a message 14 in the chat 12 being created by the user 104 in response to one or more trigger conditions occurring. By automatically providing the scheduled time 26 to the user 104, the user 104 is easily able to identify an available time to send the message 14, and thus, reducing sending the messages 14 using the chat 12 when the chat participants 16 are unavailable.

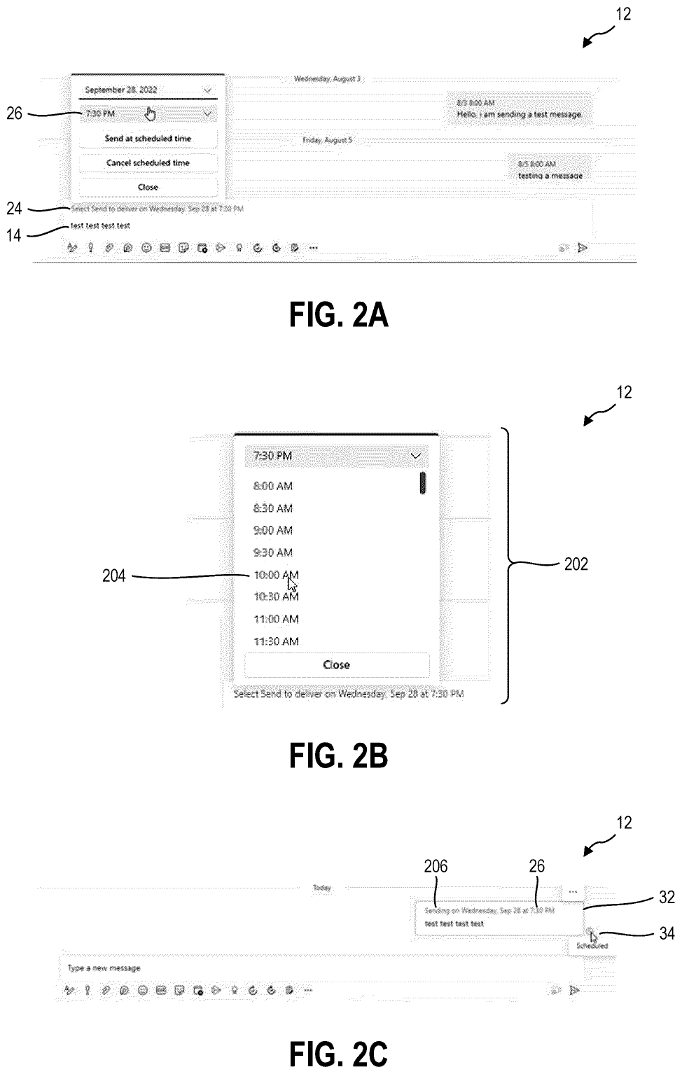

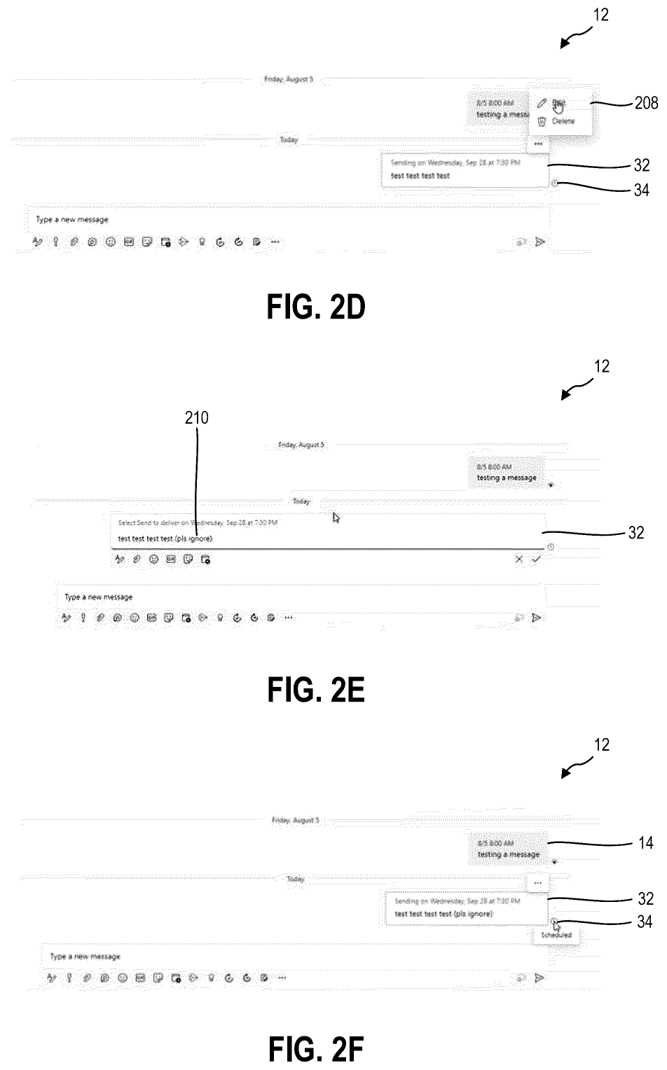

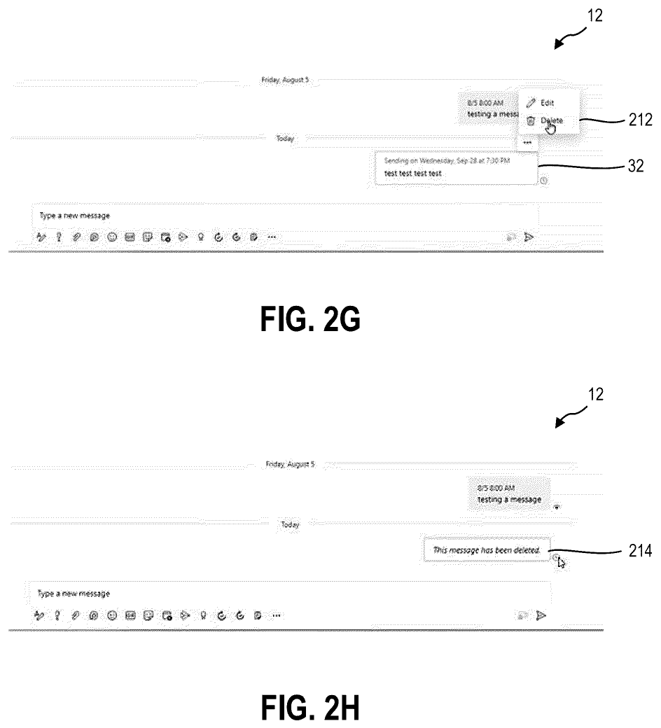

Referring now to FIG. 2A, illustrated is an example graphical user interface (GUI) of a chat 12 of a user 104 (FIG. 1) composing a message 14 to send to a chat participant 16 (FIG. 1) in the chat 12. The GUI of the chat 12 presents a suggestion 24 to delay sending a message 14 in the chat 12. The suggestion 24 includes a scheduled time 26 (Wednesday, September 28^{th} at 7:30 PM) to delay sending the message 14 until. The message suggestion component 22 (FIG. 1) sends the suggestion 24 for presentation on the chat 12 in response to determining that a trigger condition occurred (e.g., the chat participant 16 is unavailable) when the message 14 is being created. The message suggestion component 22 automatically determines the scheduled time 26 based on a time when the chat participant 16 is next available.

FIG. 2B illustrates an example GUI of the chat 12 and changing a scheduled time 26 to delay sending a message 14 in the chat 12. A list 202 of alternate times is presented to the user 104 and the user 104 selects a new time 204 (10:00 am) for the scheduled time 26 to delay sending the message 14 in the chat 12 to the chat participant 16 (FIG. 1). The message component 36 updates the scheduled time 26 based on the new time 204 selected by the user 104.

FIG. 2C illustrates an example GUI of the chat 12 and presenting a delayed message 32 in the chat 12 of a user 104 that created the delayed message 32. If the user 104 selects the suggestion 24 (FIG. 2A) to delay the sending of the message 14 (FIG. 2A) until the scheduled time 26, a delayed message 32 is generated and presented in the chat 12 of the user 104 that created the delayed message 32 without presenting the delayed message 32 in the chat of the chat participant 16 selected to receive the delayed message 32. The delayed message 32 may include a notification 206 indicating that the delayed message 32 is scheduled to send at the scheduled time 26. In addition, an icon 34 is presented nearby the delayed message 32 notifying the user 104 that the delayed message 32 is scheduled to send at a later time (e.g., the scheduled time 26).

FIG. 2D illustrates an example GUI of the chat 12 and providing a feature 208 to edit a delayed message 32. The icon 34 provides an indication to the user 104 that the delayed message 32 is scheduled to send at a later time (e.g., the scheduled time 26). The user 104 may select the feature 208 to edit the delayed message 32 prior to the scheduled time 26.

FIG. 2E illustrates an example GUI of the chat 12 and providing edits to a delayed message 32. The user 104 selected the feature 208 (FIG. 2D) to edit the delayed message 32 and provides edits 210 to the delayed message 32. The edited delayed message 32 (the delayed message 32 with the edits 210) is sent to the application service 108 for storage until the scheduled time 26.

FIG. 2F illustrates an example GUI of the chat 12 and presenting the edited delayed message 32 in the chat 12 of the user 104 that created the edited delayed message 32 without presenting the edited delayed message 32 in the chat of the chat participant 16 selected to receive the edited delayed message 32. The icon 34 indicates to the user 104 that the edited delayed message 32 is scheduled to send at a later time (e.g., the scheduled time 26). The delayed messages 32 may be visually distinct from the other messages 14 that have already been sent in the chat 12. For example, the delayed message 32 is a different color than the other messages 14 in the chat 12.

FIG. 2G illustrates an example GUI of the chat 12 and presenting a feature 212 to delete a delayed message 32. The user 104 may select the feature 212 to delete the delayed message 32 prior to the scheduled time 26.

FIG. 2H illustrates an example GUI of the chat 12 with a notification 214 indicating that the delayed message 32 is deleted from the chat 12 of the user 104 that created the delayed message 32. If the user 104 selects the feature 212 (FIG. 2G) to delete the delayed message 32, the delayed message 32 is removed from the datastore at the application service 108. In addition, the delayed message 32 is removed from the chat 12 of the user 104 that created the delayed message 32.

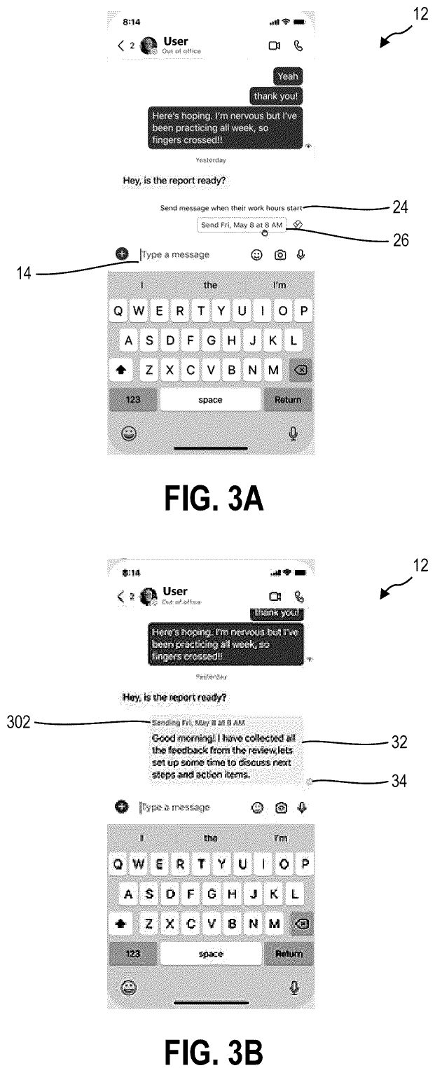

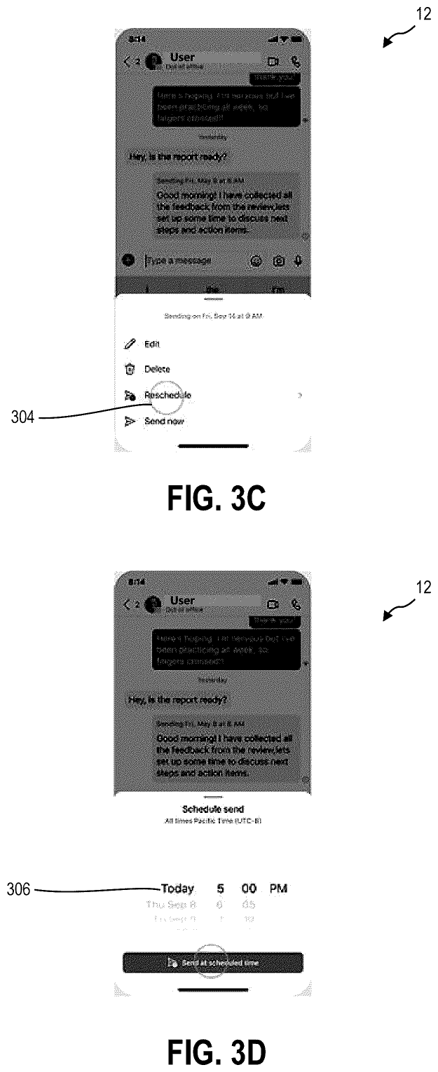

FIG. 3A illustrates an example GUI of a chat 12 presented on a mobile device of a user 104 (FIG. 1) composing a message 14 to send to a chat participant 16 (FIG. 1) in the chat 12. The GUI of the chat 12 presents a suggestion 24 to delay sending a message 14 in the chat 12. The suggestion 24 includes a scheduled time 26 (Friday, May 8^{th} at 8:00 am) to delay sending the message until. The message suggestion component 22 (FIG. 1) sends the suggestion 24 for presentation on the chat 12 in response to determining that a trigger condition occurred (e.g., the chat participant 16 is unavailable because the chat participant 16 is out of the office). The message suggestion component 22 automatically determines the scheduled time 26 based on a time when the chat participant 16 is next available (e.g., back in the office).

FIG. 3B illustrates an example GUI of a chat 12 presented on a mobile device of the user 104 and presenting a delayed message 32 in the chat 12 of the user 104 that created the delayed message 32. If the user 104 selects the suggestion 24 (FIG. 3A) to delay the sending of the message 14 (FIG. 3A) until the scheduled time 26, a delayed message 32 is generated and presented in the chat 12 of the user 104 that created the delayed message 32 without presenting the delayed message 32 in the chat of the chat participant 16 selected to receive the delayed message 32. The delayed message 32 may include a notification 302 indicating that the delayed message 32 is scheduled to send at the scheduled time 26. In addition, an icon 34 is presented nearby the delayed message 32 notifying the user 104 that the delayed message 32 is scheduled to send at a later time (e.g., the scheduled time 26).

The message component 36 synchronizes the delayed messages 32 across the chat 12 of any device that the user 104 uses to access the chat 12. For example, if the user 104 created the delayed message 32 for the chat 12 using a first device (e.g., a computer) and later accessed the chat 12 using the mobile device, the delayed message 32 is presented on both the chat 12 of the mobile device as well as on the chat 12 of the first device (e.g., the computer).

FIG. 3C illustrates an example GUI of a chat 12 presented on a mobile device of the user 104 and rescheduling a scheduled time 26 to delay sending a delayed message 32 in the chat 12. The user 104 may select a feature 304 to reschedule the scheduled time 26 to delay sending the delayed message 32.

FIG. 3D illustrates an example GUI of a chat 12 presented on a mobile device of the user 104 and provides a list of alternate times for rescheduling a scheduled time 26 to delay sending the delayed message 32 in the chat 12. For example, the user 104 selects a new time 306 (Today at 5:00 pm) as the scheduled time 26 for sending the delayed message 32 in the chat 12 to the chat participant 16 (FIG. 1). The message component 36 updates the scheduled time 26 based on the new time 306 selected by the user 104.

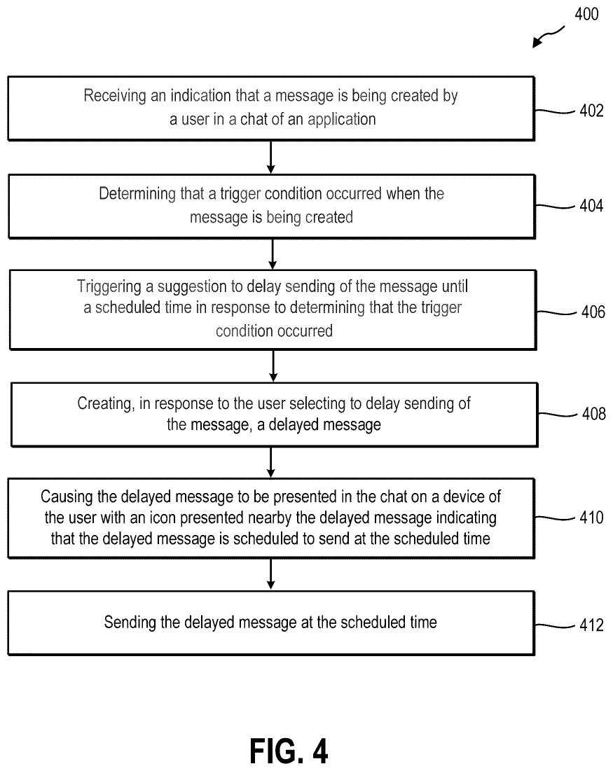

Referring now to FIG. 4, illustrate is an example method 400 for providing a suggestion to delay sending of a message in a chat and delaying a sending of the message. The actions of the method 400 are discussed below with reference to the architecture of FIG. 1.

At 402, the method 400 includes receiving a message creation indication that a message is being created by a user in a chat of an application. The message suggestion component 22 receives a message creation indication 18 from the application 10 that a message 14 is being created by the user 104 in a chat 12 of the application 10. The message creation indication 18 also includes message information, such as, the chat participants 16 selected for the message 14.

At 404, the method 400 includes determining that a trigger condition occurred when the message is being created. The message suggestion component 22 determines that one or more trigger conditions occurred when the message 14 is being created. In some implementations, the trigger condition is the message 14 is being created when a chat participant 16 is unavailable. One example of the chat participant 16 being unavailable includes the chat participant 16 is outside of work hours or is out of the office. Another example of the chat participant 16 being unavailable includes the chat participant 16 is in a meeting. Another example of the chat participant 16 being unavailable includes the chat participant 16 has an unavailable or do not disturb status. In some implementations, the message suggestion component 22 determines a trigger condition occurred by automatically determining that the chat participant 16 is unavailable based on analyzing an availability status 28 of the chat participant 16. The availability status 28 includes a do not disturb status, an available status, in a meeting status, in a call status, an out of office status, an unavailable status, quite hours status, or an offline status.

In some implementations, the message suggestion component 22 determines a trigger condition occurred by automatically determining that the chat participant 16 is unavailable based on analyzing calendar information 30 of the chat participant 16. For example, the message suggestion component 22 automatically determines that the chat participant 16 is unavailable based on analyzing preferred working hours of the chat participant 16 and a time zone of the chat participant 16.

At 406, the method 400 includes triggering a suggestion to delay sending of the message until a scheduled time in response to determining that the trigger condition occurred. The message suggestion component 22 triggers a suggestion 24 to delay sending of the message 14 until a scheduled time 26 in response to determining that the trigger condition occurred. In some implementations, the trigger condition is the chat participant 16 is unavailable and the message suggestion component 22 triggers a suggestion 24 to delay sending of the message 14 until a scheduled time 26 in response to determining that the message 14 is being created when the chat participant 16 is unavailable.

In some implementations, the scheduled time 26 is a time when the chat participant 16 is available. In some implementations, the scheduled time 26 is automatically determined by the message suggestion component 22 based on an availability status 28 of the chat participant 16. In some implementations, the scheduled time 26 is automatically determined by the message suggestion component 22 based on calendar information 30 of the chat participant 16. For example, the scheduled time 26 is automatically determined based on preferred working hours of the chat participant 16 and a time zone of the chat participant 16. In some implementations, a list of times is provided for the scheduled time 26 and the user 104 selects the scheduled time 26 from the list of times.

In some implementations, a plurality of chat participants 16 are included on the chat 12 and the scheduled time 26 is based on an earliest start of the plurality of chat participants 16 work hours. In some implementations, a plurality of chat participants 16 are included on the chat 12 and the scheduled time 26 is based on an earliest overlapping time of the plurality of chat participants 16 work hours. In some implementations, a plurality of chat participants 16 are included on the chat 12 and the scheduled time 26 is based on an overlapping time when the plurality of chat participants 16 availability status 28 indicate that the plurality of chat participants 16 are available.

At 408, the method 400 includes creating a delayed message in response to the user selecting to delay the sending of the message. The message component 36 creates the delayed message 32 in response to the user 104 selecting to delay the sending of the message 14. The message component 36 stores the delayed message at a location remote from the device 102 of the user 104 to sends the delayed message 32 at the scheduled time 26.

At 410, the method 400 includes causing the delayed message to be presented in the chat on a device of the user with an icon nearby the delayed message indicating that the delayed message is scheduled to send at the scheduled time. The message component 36 causes the delayed message 32 to be presented in the chat 12 on the device 102 of the user 104 with an icon 34 nearby the delayed message 32 indicating that the delayed message 32 is scheduled to send at the scheduled time 26. The delayed message 32 is unavailable in the chat 12 viewed by the chat participant 16.

In some implementations, the message component 36 synchronizes the delayed message 32 on the chat 12 on any device 102 that the user 104 uses to access the chat 12 by presenting the delayed message 32 with the icon 34 in the chat 12 on any device 102 that the user 104 uses to access the chat 12.

In some implementations, the message component 36 accesses the delayed message 32; generates an edited delayed message 32 with a change to the delayed message 32; stores the edited delayed message 32 at a location remote from the device 102 to send at the scheduled time 26; and synchronizing the edited delayed message 32 on the chat 12 of any device 102 that the user 104 uses to access the chat 12.

At 412, the method 400 includes sending the delayed message at the scheduled time. The message component 36 sends the delayed message 32 at the scheduled time 26 to the chat 12. The message component 36 causes the delayed message 32 to be presented in the chat 12 viewable by the user 104 and the chat participant 16.

As such, the method 400 is used to automatically provide a suggestion 24 to delay sending a message 14 that is being composed by a user 104 to send to a chat participant 16 using a chat 12 feature of an application 10.

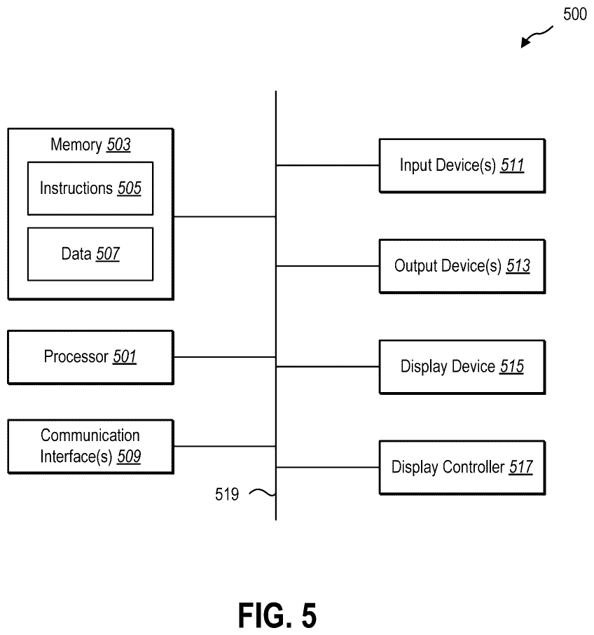

FIG. 5 illustrates components that may be included within a computer system 500. One or more computer systems 500 may be used to implement the various methods, devices, components, and/or systems described herein.

The computer system 500 includes a processor 501. The processor 501 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving a message creation indication that a message is being created by a user in a chat of an application;
determining that a trigger condition occurred when the message is being created;
triggering a suggestion to delay sending of the message until a scheduled time in response to determining that the trigger condition occurred;
creating, in response to the user selecting to delay sending of the message, a delayed message; and
causing the delayed message to be presented in the chat on a device of the user with an icon presented nearby the delayed message indicating that the delayed message is scheduled to send at the scheduled time, wherein the delayed message is unavailable in the chat viewed by a chat participant selected to receive the message.

2. The method of claim 1, further comprising:
synchronizing the delayed message on the chat on any device that the user uses to access the chat by presenting the delayed message with the icon in the chat on any device that the user uses to access the chat.

3. The method of claim 1, further comprising:
storing the delayed message at a location remote from the device of the user to send the delayed message at the scheduled time.

4. The method of claim 3, further comprising:
accessing the delayed message;
generating an edited delayed message with a change to the delayed message;
storing the edited delayed message at a location remote from the device to send at the scheduled time; and
synchronizing the edited delayed message on the chat of any device that the user uses to access the chat.

5. The method of claim 1, further comprising:
sending the delayed message at the scheduled time; and
causing the delayed message to be presented in the chat viewable by the user and the chat participant.

6. The method of claim 1, wherein the trigger condition includes determining that the chat participant is unavailable based on an availability status of the chat participant that includes a do not disturb status, an available status, in a meeting status, in a call status, an out of office status, an unavailable status, quite hours status, or an offline status.

7. The method of claim 1, wherein the trigger condition includes determining that the chat participant is unavailable based on analyzing preferred working hours of the chat participant and a time zone of the chat participant.

8. The method of claim 1, wherein the scheduled time is a time when the chat participant is available.

9. The method of claim 1, wherein the scheduled time is automatically determined based on an availability status of the chat participant.

10. The method of claim 1, wherein the scheduled time is automatically determined based on preferred working hours of the chat participant and a time zone of the chat participant.

11. The method of claim 1, wherein a list of times is provided for the scheduled time and the user selects the scheduled time from the list of times.

12. The method of claim 1, wherein a plurality of chat participants are included on the chat and the scheduled time is based on an earliest start of the plurality of chat participants work hours.

13. The method of claim 1, wherein a plurality of chat participants are included on the chat and the scheduled time is based on an earliest overlapping time of the plurality of chat participants work hours.

14. The method of claim 1, wherein a plurality of chat participants are included on the chat and the scheduled time is based on an overlapping time when the plurality of chat participants availability status indicate that the plurality of chat participants are available.

15. A device, comprising:
a processor;
memory in electronic communication with the processor; and
instructions stored in the memory, the instructions being executable by the processor to:
receive a message creation indication that a message is being created by a user in a chat of an application;
determine that a trigger condition occurred when the message is being created;
trigger a suggestion to delay sending of the message until a scheduled time in response to determining that the trigger condition occurred;
create, in response to the user selecting to delay sending of the message, a delayed message;
cause the delayed message to be presented in the chat on a device of the user with an icon presented nearby the delayed message indicating that the delayed message is scheduled to send at the scheduled time, wherein the delayed message is unavailable in the chat viewed by a chat participant selected to receive the message; and
store the delayed message at a location remote from the device of the user to send the delayed message at the scheduled time.

16. The device of claim 15, wherein the instructions are further executable by the processor to:
synchronize the delayed message on the chat on any device that the user uses to access the chat by presenting the delayed message with the icon in the chat on any device that the user uses to access the chat.

17. The device of claim 15, wherein the instructions are further executable by the processor to:
synchronize the delayed message on the chat on any device that the user uses to access the chat by presenting the delayed message with the icon in the chat on any device that the user uses to access the chat.

18. The device of claim 15, wherein the instructions are further executable by the processor to determine that the trigger condition occurred by automatically determining that the chat participant is unavailable based on analyzing an availability status of the chat participant that includes a do not disturb status, an available status, in a meeting status, in a call status, an out of office status, an unavailable status, quite hours status, or an offline status.

19. The device of claim 15, wherein the instructions are further executable by the processor to determine that the trigger condition occurred by automatically determining that the chat participant is unavailable based on analyzing calendar information of the chat participant.

20. The device of claim 15, wherein the instructions are further executable by the processor to automatically determine the scheduled time based on calendar information of the chat participant or an availability status of the chat participant.
